(19) United States
(12) Patent Application Publication
(10) Pub. No.: US 2010/0072441 A1
(43) Pub. Date: Mar. 25, 2010

(54) DEVICE FOR INTRODUCING A DRAW WIRE OR ELEMENT INTO TUBES

(76) Inventor: Andreas Haslacher, Mondsee (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/450,460

(22) PCT Filed: Mar. 27, 2008
(86) PCT No.: PCT/EP2008/053607

§ 371 Date: Sep. 28, 2009

(30) Foreign Application Priority Data
Mar. 29, 2007 (EP) 07006556.0

(51) Int. Cl. H02G 1/08

(52) U.S. Cl. 254/134.3 R

(57) ABSTRACT

The invention relates to an apparatus for introducing a draw wire (4) into tubes, comprising:
a. a first actuating body (5) in which the draw wire (4) is guided in a sliding manner;
b. a first clamping device (1, 01) that is arranged in the first actuating body (5) and that blocks and releases the movement of the draw wire (4);
c. a second actuating body (6, 7) in which the draw wire (4) is guided in a sliding manner;
d. a second clamping device (2, 02) that is preferably arranged in the second actuating body (6, 7) and that blocks and releases the movement of the draw wire (4);
e. a telescopic tube (8, 08) that connects the first clamping device (1, 01) and the second clamping device (2, 02).

Smooth introduction even in difficult situations is enabled in such a way that the telescopic tube (8, 08) is arranged to be torsionally rigid.

The present invention relates to an apparatus for introducing a draw wire into tubes, comprising:
a first actuating body in which the draw wire is guided in a sliding manner;
a first clamping device that is arranged in the first actuating body and that blocks and releases the movement of the draw wire;
a second actuating body in which the draw wire is guided in a sliding manner;
a second clamping device that is preferably arranged in the second actuating body and that blocks and releases the movement of the draw wire;
a telescopic tube that connects the first clamping device and the second clamping device.

It is common practice in the laying of electric lines, cables and water pipes to lay a tube in the brickwork at first and to insert the cables or the like at a later time. This occurs in practice in such a way that a draw wire is introduced from one pipe end in order to produce a connection with the other pipe end. The cable is then fixed to the head of the draw wire and then pulled in the opposite direction through the tube.

When the tube has a narrow cross section and there are curvatures with narrow radii, it is difficult and cumbersome to introduce the draw wire into the tube. Various apparatuses have become known with which the insertion is facilitated and can optionally be automated. Such apparatuses are complex and difficult to handle, especially when it needs to be considered that the tube ends where the draw wire needs to be inserted are often located at large heights or at places that are difficult to access.

Springs which in their arrangement correspond essentially to draw wires are also used for cleaning piping systems that are otherwise inaccessible, such as water pipes or sewage pipes. This application shall also be covered by the present invention.

An actuating body within the terms of the definition of the main claim shall be understood as being the part of the apparatus which is used to grip the same, to move the same or actuate a manual clamping device.

It is the object of the present invention to further develop an apparatus of the kind mentioned above that the insertion of draw wires is facilitated, and it should be possible in particular that the respective apparatus can be operated by one person without any assistants. It is a further object of the present invention that the apparatus is arranged in a compact and light way, so that the insertion can easily be performed without any difficulties even at locations that are difficult or a situated high up. The insertion should be possible without using any auxiliary drives, which means even when no electric power is available. It is a further object of the invention to offer an especially easy possibility to twist the draw wire during insertion in order to prevent blockages. It shall be possible in particular to use optionally available tools such as cordless screwdrivers in order to facilitate the application in difficult cases.

This object is achieved in accordance with the invention in such a way that at least one ratchet system is provided which connects a clamping device with an actuating element. The insertion of the draw wire with the apparatus in accordance with the invention occurs in an especially simple manner by a pumping motion in which the respective person slides the same back and forth when there is an actuating body or slides the same together in an alternating fashion and then pulls them apart again when there are two actuating bodies. During the first working stroke, which is when the second actuating body is pressed in the direction of the first actuating body, the second clamping device will lock, so that the draw wire can be inserted through the first actuating body into the tube, with the first clamping device releasing the motion. In the second working stroke, the second actuating body is pulled back, with the first clamping device preventing any inadvertent withdrawal of the draw wire.

The relevant aspect for the present invention is the finding that a stiff draw wire can successfully be inserted by a rotational movement about its longitudinal axis. In many cases however the angle of twist which can be exerted by twisting an actuating body on the draw wire is insufficient in order to achieve ability to penetrate. By providing a ratchet system, a twisting of the draw wire about its longitudinal axis about an angle of random size can be achieved by twisting an actuating body or any other actuating element back and forth. This enables a considerable increase in the functionality of the apparatus.

It is advantageous when the first clamping device in the first actuating body blocks the draw wire in a predetermined direction and releases the same in the opposite direction. It thus concerns an automatically working clamping device which can make do without any manual clamping and release manipulations. The same applies to the second clamping device.

An especially preferred embodiment of the invention provides that the first clamping device is held to be twistable in relation to the first actuating body. As a result, the clamping device can be uncoupled in relation to twisting moments which are then introduced separately via components that are better suited for this purpose. The same applies according to a further variant for the second clamping device.

An especially simple operation, especially in connection with a twisting of the draw wire, can be achieved in such a way that a clamping device is connected with at least one ratchet system which is arranged as a double-ratchet system which produces a radial rotational movement of the clamping device by cooperation of two freewheel bearings/ratchet systems by simple ratchet movement of the actuating bodies.

A further especially advantageous embodiment of the present invention provides a further clamping apparatus which enables an optional tight clamping of the draw wire. The relevant aspect in this embodiment is the finding that it is theoretically possible to also exert a twisting moment on the draw wire by the first or second clamping device in the clamped state. However, these clamping devices are optimized to the forward feed of the draw wire in the axial direction and are unable to transmit the required twisting moments in a satisfactory manner. As a result of a third clamping device, a substantially larger twisting moment can be transmitted, thus expanding the field of application of the apparatus to more difficult conditions. In this context it is further preferable when the further clamping device is connected with an actuating body. An especially compact configuration can thus be achieved in this manner.

It is alternatively also possible that the further clamping device is arranged as a fixing device for the first or second clamping device. Although the same twisting moments are usually not achieved as in the case of a clamping device dedicated to torsion, an especially simple arrangement can be realized.

It is preferably also possible that the further clamping device is connected to at least one radial bearing. It is possible in this manner to uncouple further components in respect of torsion, which further simplifies operation.

Preferably, a telescopic tube is provided which is torsionally rigid. The relevant aspect is that it should be possible, depending on the respective operating state of the apparatus, to exert a torque on the draw wire about the longitudinal axis. It should also be possible to perform an encompassing motion when the angle of twist is insufficient when the actuating body is tightly held in order to successfully introduce the draw wire in case of bends and long lines. The torsionally rigid telescopic tube now enables the two actuating bodies to be coupled with one another in the rotational direction, which causes a considerable increase in the functionality.

The operation of the apparatus can further be simplified in such a way that the further clamping device is arranged as a handle which can be twisted in relation to the actuating body.

A further preferred solution in connection with the present invention provides that a transmission gearing is provided which acts in the radial direction of the further clamping device and moves the same about its own axis and which is preferably arranged as a speed-increasing gear. The relevant aspect in this variant is the finding that a draw wire can be made to offer better penetration by a rotational movement about its longitudinal axis in order to enable successfully inserting the draw wire in the case of bends and long lines. This rotational movement can be exerted on the draw wire by twisting an actuating body or any other actuating element. As a result of the anatomical conditions, the angle of twist is limited when the actuating body is tightly held and is approximately 90° for example. As a result of the transmission gearing in accordance with the invention, this angle by which the draw wire can be twisted with a continuous movement of the hand can be increased substantially.

An especially high twisting moment is achieved in such a way that the further clamping device comprises jaws which can be pressed against the draw wire.

A ratchet-like function in connection with the twisting of the draw wire can be realized in such a way that the further clamping device comprises an eccentric-shaped jaw which can be pressed against the draw wire in a self-supporting manner.

It is further preferable that the further clamping device can be locked and unlocked manually. The twisting movement can thus be controlled in any desired way.

An increase in the functionality can also be achieved in such a way that the first clamping device and the second clamping device each comprise a switchable clamping device.

An especially simple and robust solution can be realized in such a way that the clamping devices are arranged as pawls.

An alternative solution for forming automatically acting clamping devices provides that the clamping devices are arranged as a cone through which the draw wire is guided and in which clamping balls are arranged in order to block the movement of the draw wire in one direction.

It is further advantageous when a mouthpiece for inserting the draw wire into an opening of the tube is provided on the actuating body and that the mouthpiece comprises a flexible hose which guides the draw wire. The insertion of the draw wire can thus be further facilitated considerably.

In this connection it is especially advantageous when the mouthpiece comprises a flexible hose which guides the draw wire and is provided with a mechanical clamping element which is provided with a quick acting fastener for tight clamping to electric hoses and tubes. The apparatus can thus be fastened to the insertion opening, which further simplifies manipulation.

The invention will now be explained in closer detail by reference to the embodiments shown in the drawings, wherein:

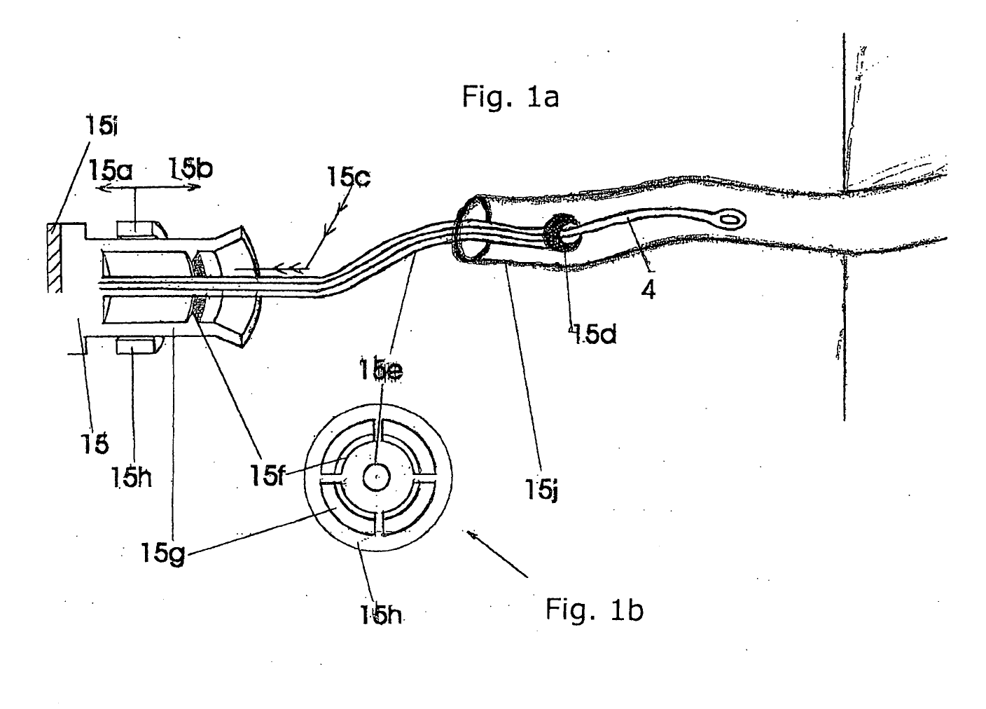

FIG. 1a schematically shows a mouthpiece 10 of a clamping device in accordance with the invention;

FIG. 1b shows a view of the mouthpiece 10 of FIG. 1a from the front;

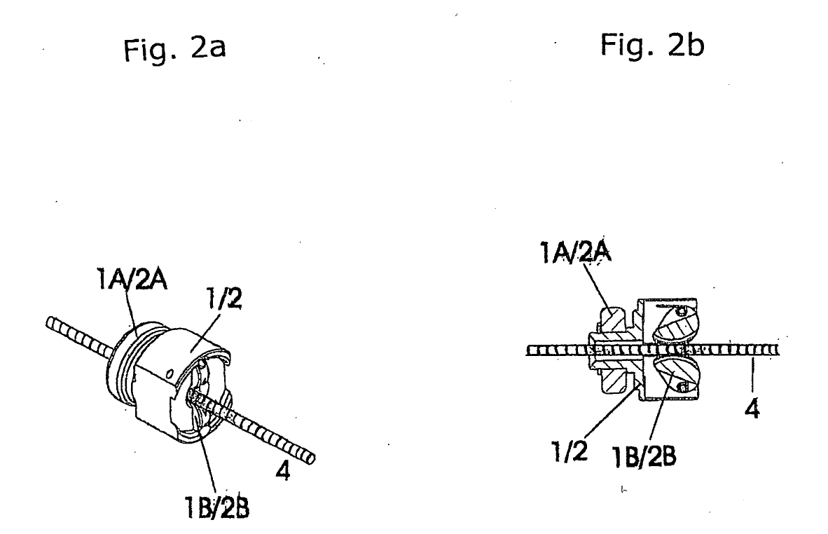

FIG. 2a shows an axonometric view of an automatic clamping device;

FIG. 2b shows an alternative embodiment of a clamping device in a longitudinal sectional view;

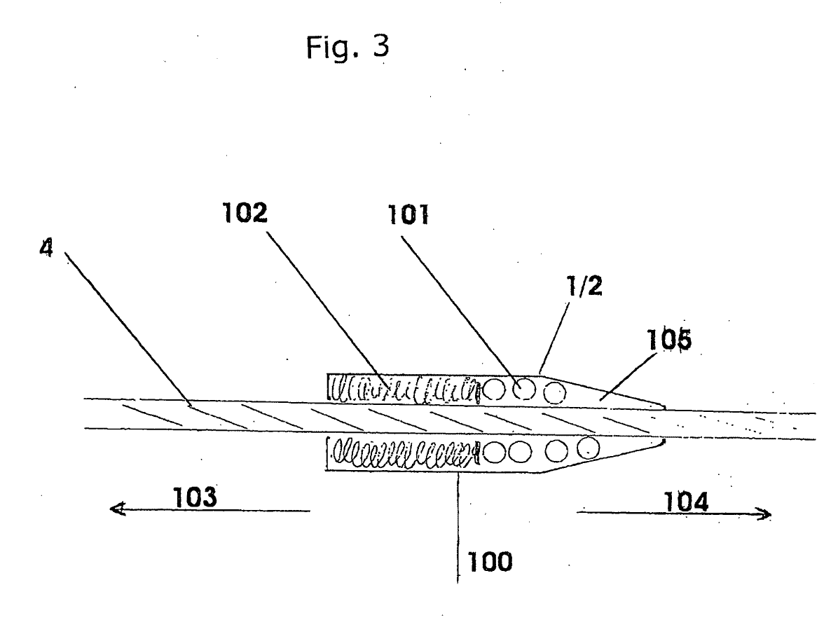

FIG. 3 shows a further embodiment of a clamping device in a longitudinal sectional view;

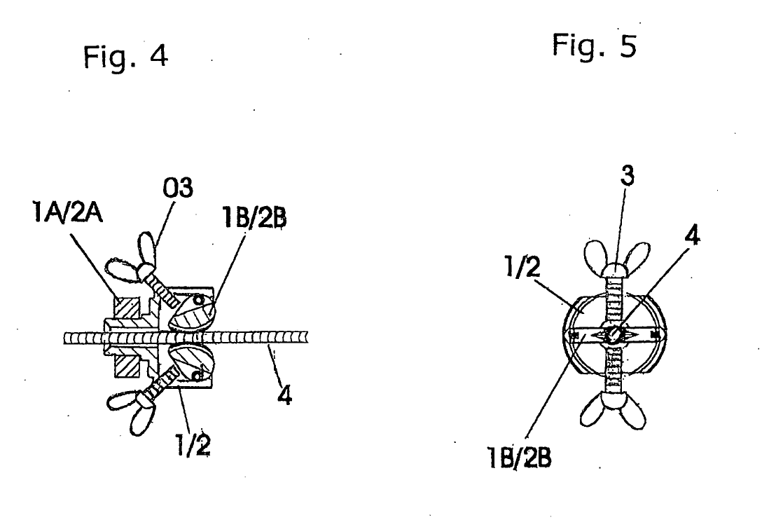

FIG. 4 shows a further embodiment of a clamping device in a longitudinal sectional view;

FIG. 5 shows a further embodiment of a clamping device in a cross-sectional view;

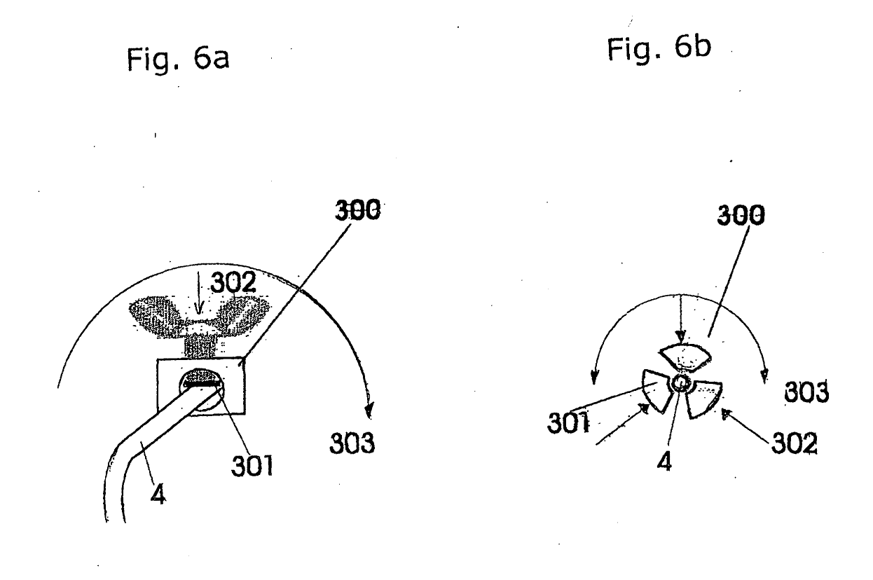

FIG. 6a shows an embodiment of a further clamping device in an axonometric view;

FIG. 6b shows the embodiment of FIG. 6a in a cross-sectional view;

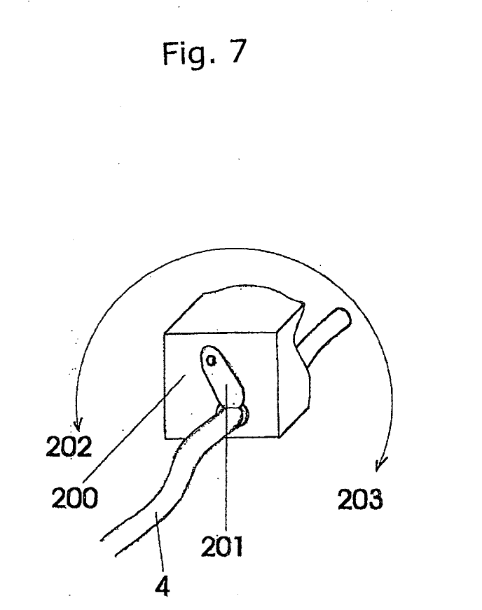

FIG. 7 shows a further embodiment of the further clamping device in an axonometric view;

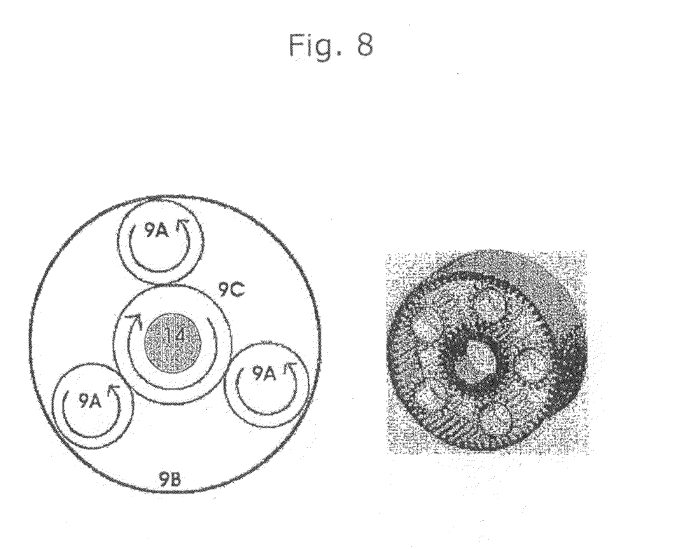

FIG. 8 shows a schematic illustration of a transmission gearing in a diagram and an axonometric view;

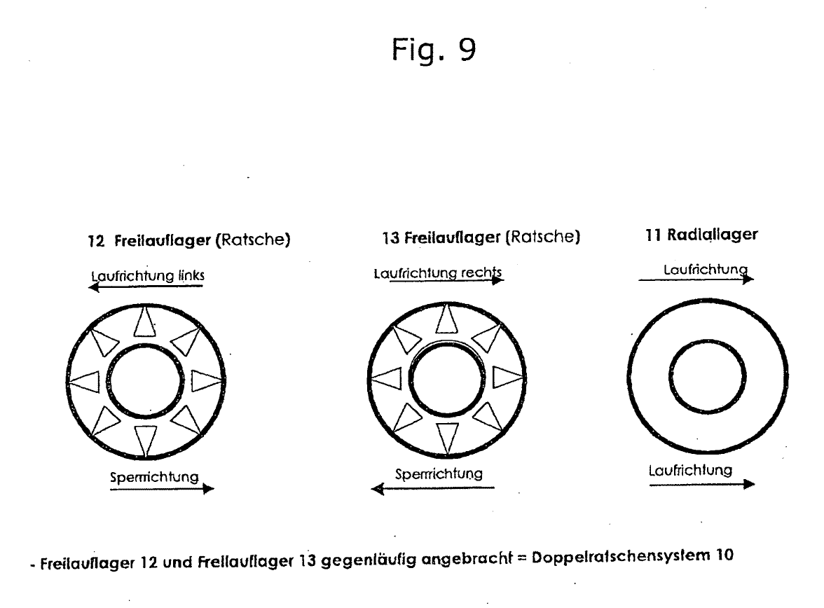

FIG. 9 shows three diagrams which explain the effect of freewheel bearings and ratchets;

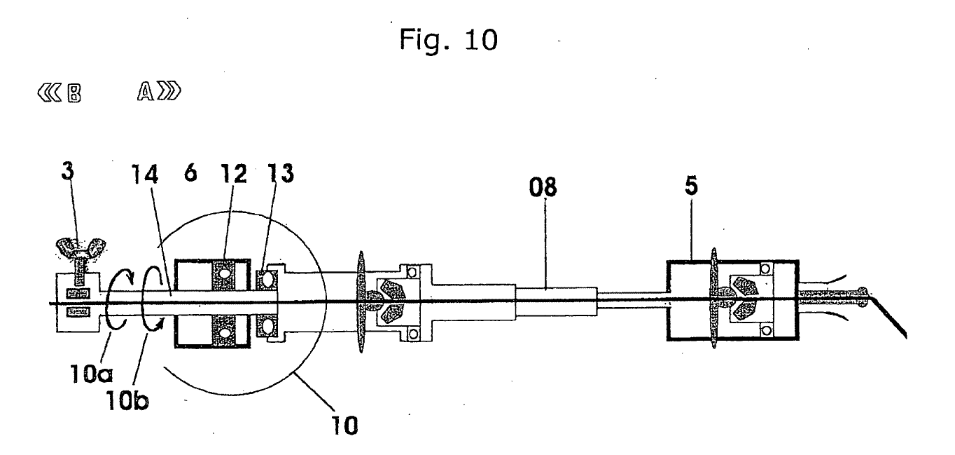

FIG. 10 shows an embodiment of the invention in a schematic longitudinal sectional view;

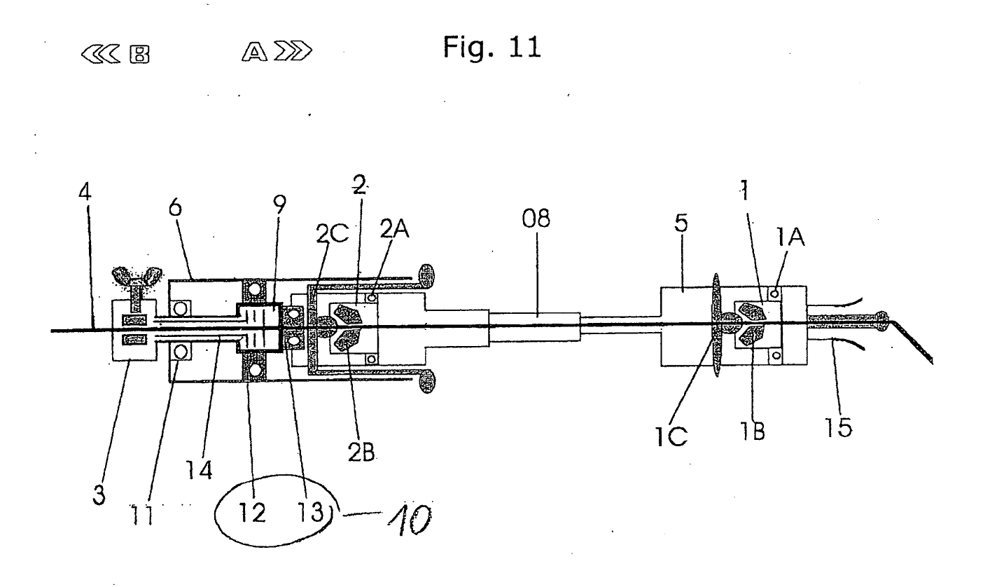

FIG. 11 shows an alternative embodiment of the invention in a schematic longitudinal sectional view;

FIG. 11b shows a further alternative embodiment of the invention in a schematic longitudinal sectional view;

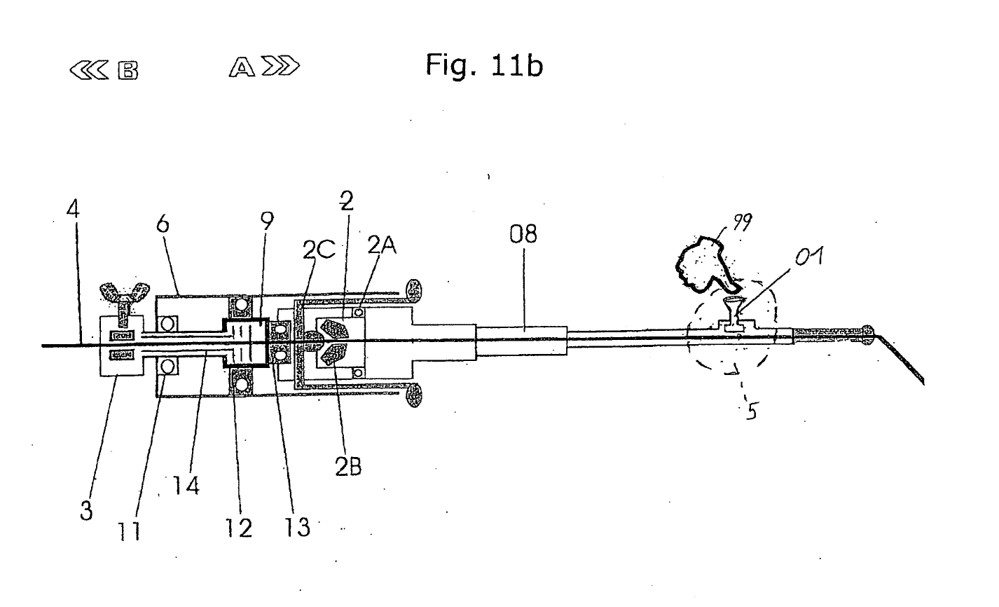

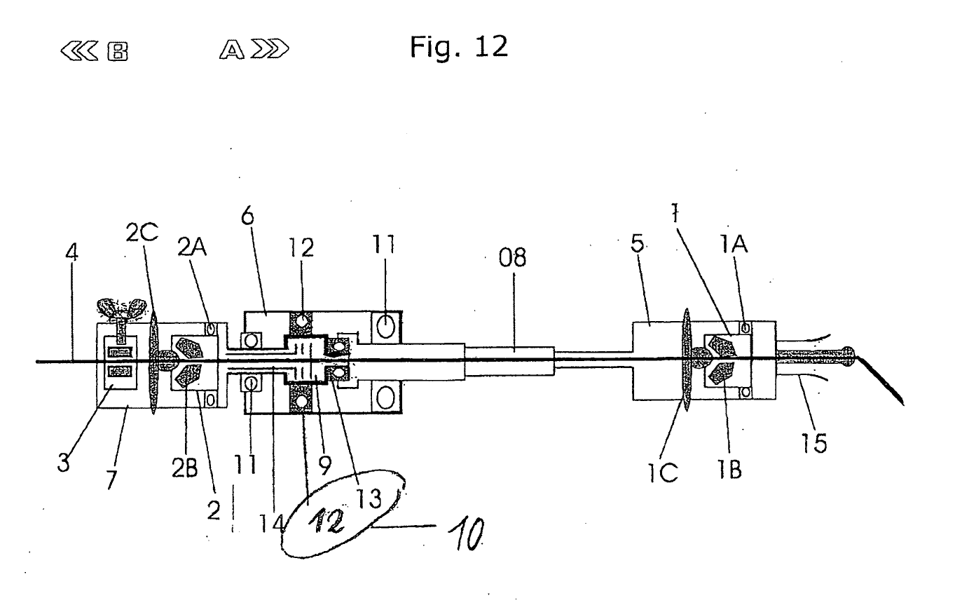

FIG. 12 shows an alternative embodiment of the invention in a schematic longitudinal sectional view;

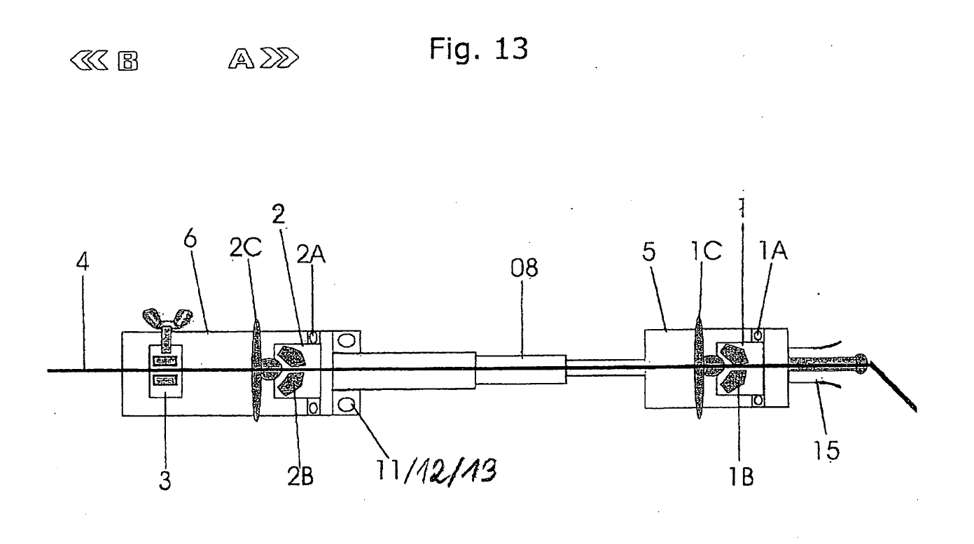

FIG. 13 shows an alternative embodiment of the invention in a schematic longitudinal sectional view;

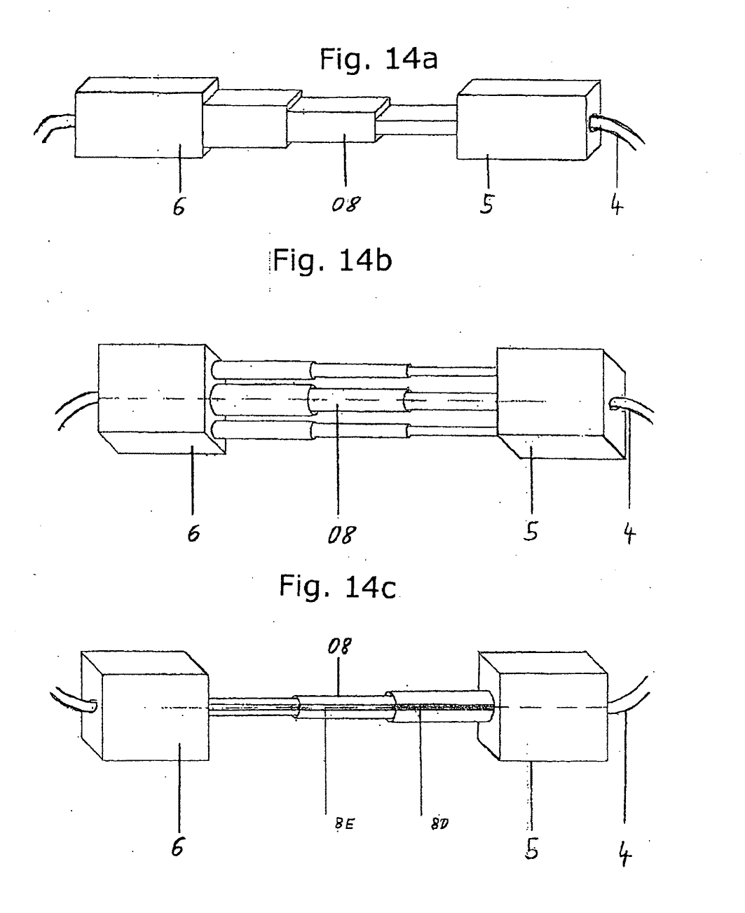

FIG. 14a shows various embodiments of torsionally rigid telescopic tubes in axonometric views;

FIG. 14b shows various embodiments of torsionally rigid telescopic tubes in axonometric views;

FIG. 14c shows various embodiments of torsionally rigid telescopic tubes in axonometric views, and

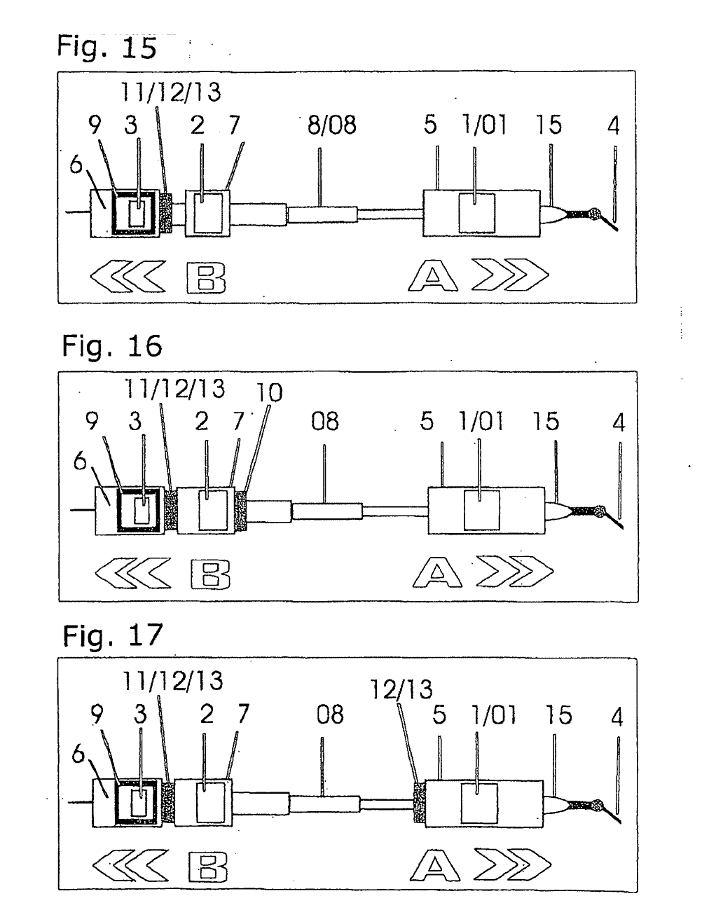

FIGS. 15 to 28 show different embodiments of the invention in schematic views.

The reference numerals used in the drawings are summarized in tables in the annex of the description.

FIGS. 1a and 1b show a possible embodiment of the front end of an apparatus in accordance with the invention. A flexible hose (steel spring core 15e) in the interior of which the draw wire 4 is arranged is introduced into the open end of an electric hose 15j, which draw wire enables the insertion into openings (electric sockets, electric lines, etc.) through its stability.

The flexible hose 15e is enclosed by clamping jaws 15g which enables the electric line 15j to be tightly clamped by insertion into the opening of 14c.

The clamping jaws 15g are connected at their root to a mouthpiece 15. A clamping web 15f can be compressed by axial displacement of the clamping ring 15h in order to bring the clamping jaws 15g into tight engagement with the electric hose 15j. The mouthpiece 15 is connected with the electric hose 15j through this mechanical clamping process.

As a result of the clip-on coupling or quick-acting fastener 15i, the mouthpiece 15 can be exchanged easily and quickly on the insertion support or apparatus for a mouthpiece 15 with another embodiment which fits the circumstances.

Clamping jaws 1B, 2B are provided in the clamping apparatus 1 or 2 as shown in FIG. 2a, which jaws are arranged as a result of their mechanical configuration or shape and their spring effect to be self-working, i.e. they are self-arresting in the working direction, which means they are clamping, and are self-unlocking in the direction of retraction.

The clamping device 1, 2 can be rotated freely about its own axis by a radial bearing 1a, 2a which is attached to the clamping body. This embodiment allows a rotational movement of the draw wire 4 in the clamped state and a forward feed or axial action of force which ensures the forward feed of the draw wire and the rotational movement (this is enabled by a configuration with a cordless drill, with the draw wire 4 being made to rotate by a second person) and the draw wire 4 is pushed in by the insertion apparatus on the electric lines under rotational movement. This is frequently performed under very difficult conditions and long lines or obstructions.

FIG. 2b shows the embodiment of FIG. 2a in a longitudinal sectional view.

An alternative clamping device is shown in FIG. 3. This clamping device comprises a cone 105 in which clamping balls 101 are arranged which enclose the draw wire 4. A tension spring 102 presses the clamping balls 101 in the blocking direction 104 of the draw wire 4. The clamping device can be moved with minimal force in the freewheeling direction 103.

FIG. 4 shows a detail of a solution in which the one clamping device 3 is integrated in an automatic clamping device 2 in such a way that the clamping jaws or pawls 2B are tightly clamped on the draw wire 4 by manual engagement in the clamping mechanism 03 in such a way that a twisting moment can also be exerted on the draw wire 4 in order to twist the same about its own axis.

FIG. 5 shows an alternative solution for the integration of the clamping device 3 in the automatic clamping device 2 in order to move the same about its own axis.

In the embodiment of FIG. 6a, the clamping jaws 301 are pressed in the radial direction on the draw wire 4, so that it can be twisted about its axis according to the part 303.

Alternatively, such tight clamping can occur by three clamping jaws 301 which are pressed in the radial direction 302 against the draw wire 4.

The clamping device of FIG. 7 is designated in its entirety with reference numeral 200 and comprises an eccentric-shaped pawl which is used to block automatically in the direction 203 in order to exert a twisting moment on the draw wire 4 on the one hand, but to enable free twisting in the direction 202 on the other hand.

FIG. 8 shows the arrangement of a transmission gearing in the manner of a planetary gear. A speed-increasing gearing is possible by moving the actuating bodies 5, 6, 7 via the ring gear 9b and the planetary gears 9a on the sun gear 9c, which on its part moves the hollow shaft 14 and the connected clamping device 303 about the own axis.

FIG. 9 shows schematically that the individual ratchets or freewheel bearings 12, 13 have a blocking direction and a running direction. There is no blocking direction in a radial bearing 11 and it is freely rotatable in both directions.

FIG. 10 shows an embodiment in which the double-ratchet system is designated with reference numeral 10 which causes a radial rotational movement of the clamping device 3 by alternating movement of the actuating body 6, 7 in the direction 10a and direction 10b by cooperation of two ratchets or freewheel bearings 12, 13.

When the actuating body 6 is actuated in the direction 10a, the ratchet or freewheel bearing 12 releases this movement by its running direction of the ratchet or freewheel bearing 13 blocks the hollow shaft 14 which is fixedly connected with the clamping device 3, so that the same is moved.

When the actuating body 6 is actuated in the direction 10b, the ratchet or freewheel bearing 12 blocks the connection to the hollow shaft 14 and the ratchet or freewheel bearing 13 releases this direction, so that the clamping 13 which is connected directly with the hollow shaft 14 will be moved radially about its own axis in the direction 10b.

In the case of a double-ratchet system, it is understood that a transmission gearing 9 can be installed between the clamping device 3 and the double-ratchet system 10, so that the working movement 10b is subjected to speed-increasing gearing by the movement of the actuating body 6 on the clamping device 3. The transmission ratio shall preferably be approx. 1:4.

FIG. 11 shows a further embodiment of the invention. The double-ratchet system 10 is realized by two freewheel bearings 12, 13 which cooperate with a hollow shaft 14 via a gearing 9.

FIG. 11b shows a further embodiment of the invention which corresponds substantially to the one of FIG. 11. The difference is that the first actuating body 5 is arranged as a section of the telescopic tube 08, on which a manual actuating device is provided which can be operated with the hand 99 which is indicated schematically.

In the embodiment of FIG. 12, which is arranged similarly to the one of FIG. 11, the hollow shaft 14 is in connection with an actuating body 7 in which the clamping devices 2 and 3 are integrated.

FIG. 13 shows a further preferred embodiment of the invention in which the clamping devices 2 and 3 are integrated in the second actuating body 6.

FIGS. 14a, 14b and 14c show three different embodiments of a torsionally rigid telescopic tube 08. In the variant of FIG. 14a, twisting is prevented by a non-circular arrangement of the individual telescopic elements. In the variant of FIG. 14b, several telescopic tubes are arranged next to one another, so that twisting is not possible. FIG. 14c shows a variant in which twisting is prevented by an arrangement with groove 8D and spring 8E.

FIGS. 15 to 26 show different modifications of solutions in accordance with the invention in schematic views.

The embodiment of FIG. 15 comprises a further clamping device 3 which is connected via a radial bearing 11 or via a ratchet system 12, 13 with the second clamping device 2 in the actuating body 7. The telescopic tube 8, 08 can be arranged to be torsionally rigid or torsionally not rigid. Similarly, the first clamping device 1, 01 can be arranged to be automatic or manual.

The embodiment of FIG. 16 differs from the one of FIG. 15 in the respect that the telescopic tube 08 is arranged to be rigid and is in connection with the actuating body 7 via a double-ratchet system 10. In FIG. 17 a ratchet system 12, 13 is provided ceteris paribus at the front end of the rigid telescopic tube 08.

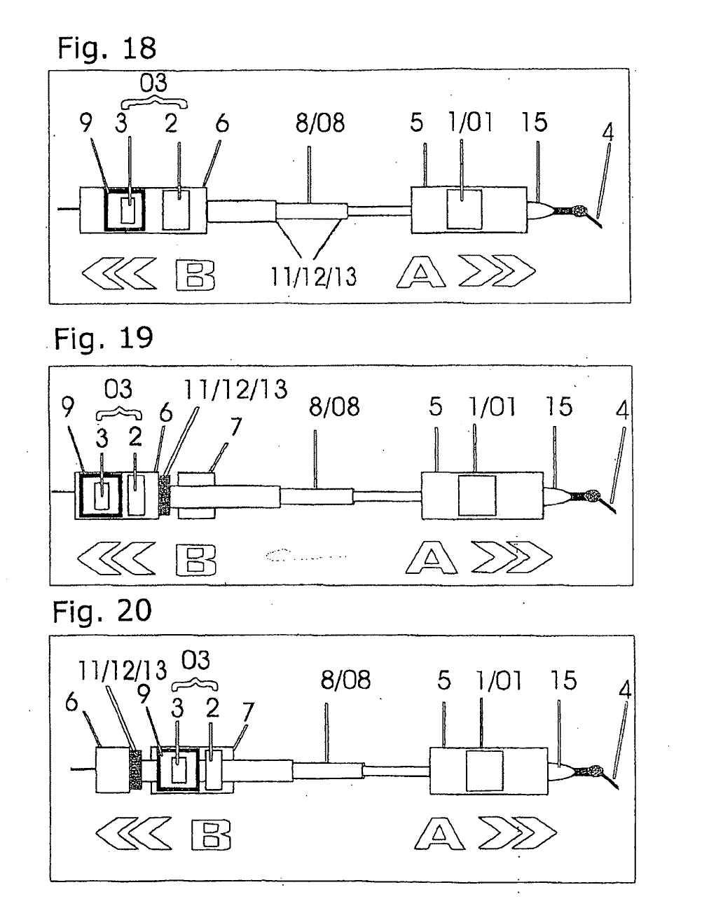

In FIG. 18, the second and further clamping device 2 and 3 are jointly arranged in the second actuating body 6. A manual clamping device 03 is thus formed in its entirety.

In the embodiment of FIG. 19, the actuating body 6 is connected via a radial bearing 11 or a ratchet system 12, 13 with a rigid or non-rigid telescopic tube 8, 08 on which a further actuating body 7 is arranged.

FIG. 20 shows an embodiment in which a second clamping device 2 and a further clamping device 3 are integrated in an actuating body 7, which clamping devices are connected via a radial bearing 11 or a ratchet system 12, 13 with a second actuating body 6 which is arranged behind the same.

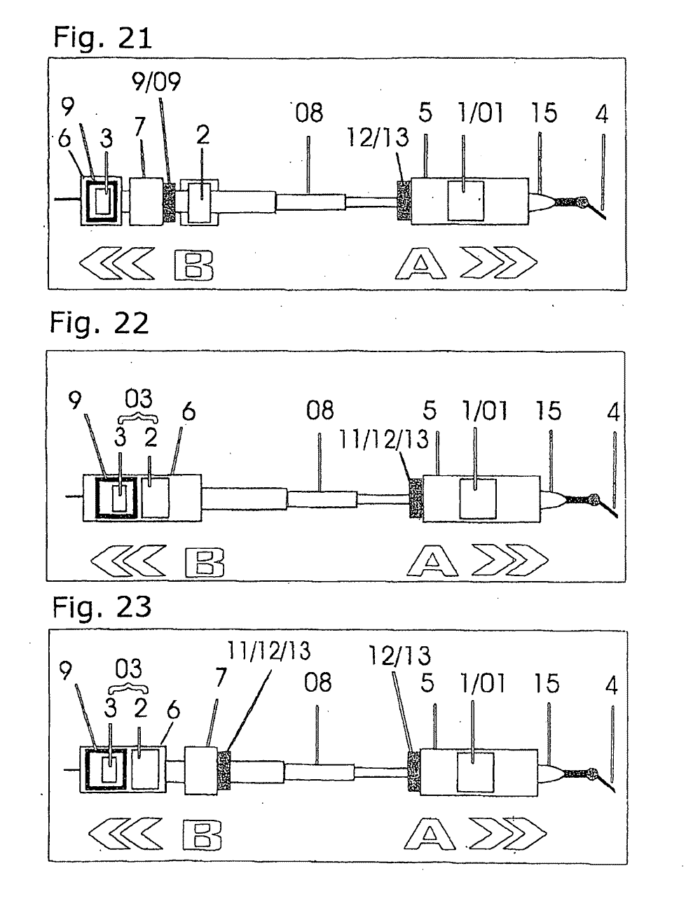

FIG. 21 shows an embodiment in which the second clamping device 2 is arranged at the rear end of the apparatus, which clamping device is connected via a first gearing 9, 09 with an actuating body 7, behind which a second actuating body 6 is arranged with a clamping device 3 arranged therein. As in the embodiment as described above, the further clamping device 3 is connected via a transmission gearing 9 with the other components.

The embodiment of FIG. 22 corresponds substantially to the one of FIG. 17 with the difference that the clamping devices 2 and 3 are integrated in a common actuating body 6. A similar solution is also disclosed in FIG. 23, with a further actuating body 7 being provided here in addition on the telescopic tube 08.

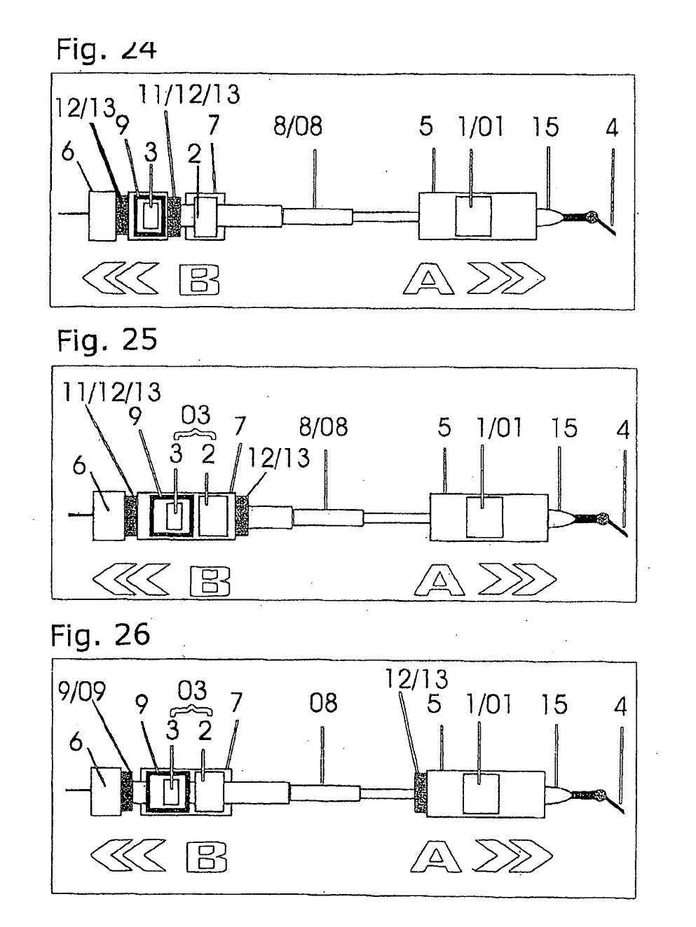

In the embodiment of FIG. 24, the further clamping device 3 is connected on both sides via radial bearings 11 or ratchet systems 12, 13 with the actuating bodies 7.

In the embodiments of FIGS. 25 and 26, the two actuating devices 2 and 3 are integrated in the further actuating body 7.

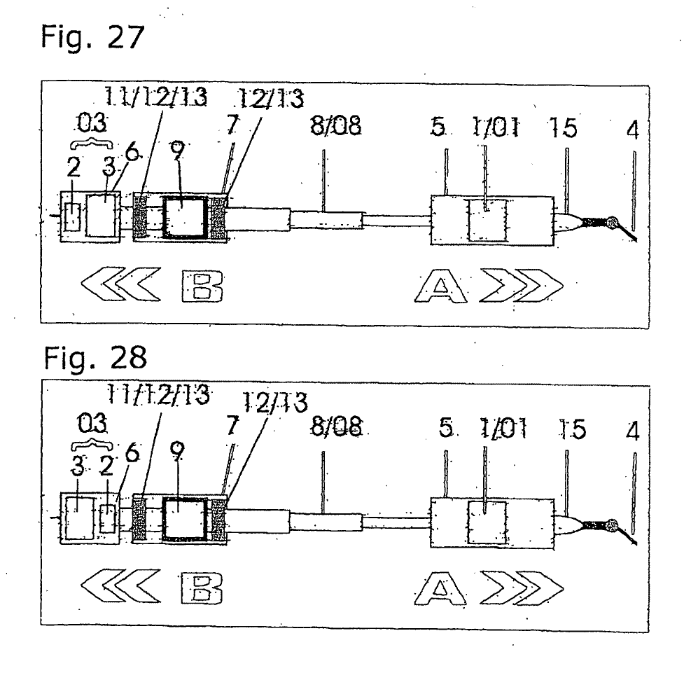

FIG. 27 shows an embodiment in which a transmission 9 is provided on both sides with a radial bearing 11 or freewheeling system 12, 13 and is in connection on the one hand with an actuating body 6 and on the other hand with the telescopic tube. Clamping devices 2 and 3 are integrated in the actuating body 6.

FIG. 28 differs from FIG. 27 in such a way that the arrangement of the two clamping devices 2 and 3 is chosen in a reverse manner.

Caption on the illustrated embodiments

| | |
|---|---|
| 01 | Manual clamping device |
| 1 | Automatic arrangement of the clamping device 01 |

| | |
|---|---|
| 1A | Radial bearing of clamping device 1 |
| 1B | Pawls of the automatic clamping device 1 |
| 1C | Unlocking and activation apparatus for |
| | automatic clamping device 1 |

Variant of the clamping
device 1

| | |
|---|---|
| 100 | Clamping device by cone with balls |
| 101 | Clamping balls |
| 102 | Tension spring |
| 103 | Freewheeling direction of spring 4 |
| 104 | Blocking direction of spring 4 |
| 105 | Cone |

| | |
|---|---|
| 02 | Manual clamping device |
| 2 | Automatic arrangement of clamping device 02 |

| | |
|---|---|
| 2A | Radial bearing of clamping device 2 |
| 2B | Pawls of automatic clamping device 2 |
| 2C | Unlocking and activation apparatus for |
| | automatic clamping device 2 |

Variant of the clamping
device 2

| | |
|---|---|
| 100 | Clamping device by cone with balls |
| 101 | Clamping balls |
| 102 | Tension spring |
| 103 | Freewheeling direction of spring 4 |
| 104 | Blocking direction of spring 4 |
| 105 | Cone |

| | |
|---|---|
| 3 | Manual clamping device |
| 03 | Manual clamping device 3 integrated in automatic clamping |
| | device (2) |
| | Variant of clamping device 3 as an automatic clamping apparatus |

| | |
|---|---|
| 200 | Radial clamping device by eccentric-shaped |
| | jaws |
| 201 | Eccentric-shaped pawl in the radial direction |
| 202 | Direction of twisting (radial) - clamping release |
| 203 | Direction of clamping and twisting (radial) |

Variant of the clamping
device 3

| | |
|---|---|
| 300 | A clamping device by mechanical pressing of |
| | pressing jaws |
| 301 | Pressing jaws |
| 302 | Pressing direction of pressing jaws |
| 303 | Direction of twisting of the clamping device |

| | |
|---|---|
| 4 | Draw wire |
| 5 | Actuating body |
| 6 | Actuating body |
| 7 | Actuating body |
| 8 | Telescopic tube in which the individual bars are rotatable radially |
| 08 | Telescopic tube in which the individual bars are not rotatable |
| | radially (rigid) |

| | |
|---|---|
| 8A | Possible embodiment of a radially torsionally |
| | rigid telescopic system |
| 8B | Possible embodiment of a radially torsionally |
| | rigid telescopic system |
| 8C | Possible embodiment of a radially torsionally |
| | rigid telescopic system |
| 8D | Groove |
| 8E | Spring |

| | |
|---|---|
| 9 | Transmission gearing |

| | |
|---|---|
| 9a | Planet carrier |
| 9b | Planet carrier (ring gear) |
| 9c | Sun wheel |
| 14 | Hollow shaft |

| | |
|---|---|
| 10 | Double-ratchet system |

| | |
|---|---|
| 12 | Ratchet system - freewheeling bearing, left run |
| 13 | Ratchet system - freewheeling bearing, right |
| | run |

| | |
|---|---|
| 11 | Radial bearing |
| 12 | Ratchet system - freewheeling bearing, left run |
| 13 | Ratchet system - freewheeling bearing, right run |
| 14 | Hollow shaft |
| 15 | Mouthpiece |

| | |
|---|---|
| 15a | Direction of relaxation |
| 15b | Clamping direction |
| 15c | Insert opening for electric lead |
| 15d | Insertion nose |
| 15e | Flexible hose |
| 15f | Clamping web |
| 15g | Clamping jaws |
| 15h | Fixing or clamping ring |
| 15i | Clip-on coupling or quick acting fastener on |
| | actuating body 1 |
| 15j | Electric line or electric hose |

1. An apparatus for introducing a draw wire (4) into tubes, comprising:
a first actuating body (5) in which the draw wire (4) is guided in a sliding manner;
first clamping device (1, 01) that is arranged in the first actuating body (5) and that blocks and releases the movement of the draw wire (4);
a second actuating body (6, 7) in which the draw wire (4) is guided in a sliding manner;
a second clamping device (2, 02) that is preferably arranged in the second actuating body (6, 7) and that blocks and releases the movement of the draw wire (4);
a telescopic tube (8, 08) that connects the first clamping device (1, 01) and the second clamping device (2, 02);
wherein at least one ratchet system (10, 12, 13) is provided which connects a clamping device (01, 1; 02, 2; 03, 3) with an actuating element.

2. The apparatus according to claim 1, wherein the clamping device (1) in the first actuating body (5) blocks the draw wire (4) in a predetermined direction and releases the same in the opposite direction.

3. The apparatus according to claim 1, wherein the second clamping device (2) in the second actuating body (6, 7) blocks the draw wire (4) in a predetermined direction and releases the same in the opposite direction.

4. The apparatus according to claim 1, wherein the first clamping device (01, 1) is held to be twistable in relation to the first actuating body (5).

5. The apparatus according to claim 1, wherein the second clamping device (02, 2) is held to be twistable in relation to the second actuating body (6, 7).

6. The apparatus according to claim 1, wherein the ratchet system is arranged as a double-ratchet system (10).

7. The apparatus according to claim 1, wherein a further clamping apparatus (03, 3) is provided which enables an optional tight clamping of the draw wire (4).

8. The apparatus according to claim 7, wherein the further clamping device (03, 3) is connected with an actuating body (5, 6, 7).

9. The apparatus according to claim 7, wherein the further clamping device (03, 3) is arranged as a fixing device for the first or second clamping device (01, 1; 02, 2).

10. The apparatus according to claim 7, wherein the further clamping device (03, 3) is connected with at least one radial bearing (12, 13).

11. The apparatus according to claim 1, wherein the telescopic tube (08) is arranged in a torsionally rigid manner.

12. The apparatus according to claim 7, wherein the further clamping device (03, 3) is arranged as a handle which can be twisted in relation to the actuating body (6).

13. The apparatus according to claim 7, wherein a transmission gearing (9) is provided which acts in the radial direction of the further clamping device (03, 3) and moves the same about its own axis and which is preferably arranged as a speed-increasing gear.

14. The apparatus according to claim 7, wherein the further clamping device (03, 3) comprises jaws (301) which can be pressed against the draw wire (4).

15. The apparatus according to claim 7, wherein the further clamping device (03, 3) comprises an eccentric-shaped jaw (201) which can be pressed against the draw wire (4) in a self-supporting manner.

16. The apparatus according to claim 7, wherein the further clamping device (03, 3) can be locked and unlocked manually.

17. The apparatus according to one claim 1, wherein the first clamping device (1) and the second clamping device (2) each comprise a switchable clamping device.

18. The apparatus according to claim 1, wherein the clamping devices (1, 2) are arranged as pawls (1B, 2B).

19. The apparatus according to claim 1, wherein the clamping devices (1, 2) are arranged as a cone (105) through which the draw wire (4) is guided and in which clamping balls (101) are arranged in order to block the movement of the draw wire (4) in one direction.

20. The apparatus according to claim 1, wherein a mouthpiece (15) for inserting the draw wire (4) into an opening of the tube (15j) is provided on the actuating body (5) and the mouthpiece (15) comprises a flexible hose (15e) which guides the draw wire (4).

21. The apparatus according to claim 1, wherein the mouthpiece (15) comprises a flexible hose (15e) which guides the draw wire (4) and is provided with a mechanical clamping element (15f, 15g, 15h) which is provided with a quick acting fastener for tight clamping to electric hoses and tubes.
